(19) United States
(12) Patent Application Publication
(10) Pub. No.: US 2024/0286457 A1
(43) Pub. Date: Aug. 29, 2024

(54) METHOD FOR OPERATING A REFRIGERATED VEHICLE, AND REFRIGERATED VEHICLE

(71) Applicant: Messer SE & Co. KGaA, Bad Soden (DE)

(72) Inventor: Jean-Claude Claeys, Zwijndrecht (BE)

(73) Assignee: Messer SE & Co. KGaA, Bad Soden (DE)

(21) Appl. No.: 18/571,450

(22) PCT Filed: Jun. 24, 2022
(86) PCT No.: PCT/EP2022/067459

§ 371 Date: Dec. 18, 2023

(30) Foreign Application Priority Data
Jun. 25, 2021 (DE) 10 2021 003 305.1

(51) Int. Cl. B60H 1/32; F17C 7/02

(52) U.S. Cl. CPC B60H 1/3202; F17C 7/02; F17C 2205/0352; F17C 2221/013; F17C 2221/014; F17C 2223/0161; F17C 2265/065; F17C 2270/0171

(57) ABSTRACT

In a first, mobile operating state of a refrigerated vehicle, which is equipped with a storage region for the transport of refrigerated products in order to maintain the cold chain, the products are transported, wherein the refrigerant for cooling the storage region is drawn from a refrigerant tank disposed on the refrigerated vehicle. According to the invention, in a second, stationary operating state of the refrigerated vehicle, the refrigerant for cooling the storage region is drawn from a stationary storage tank, the refrigerant tank being bypasses. Thus, long breaks in operation, for example at the weekend, can be bridged, so that the cold chain can be maintained without the need to transfer products which are to be refrigerated out of the refrigerated vehicle.

### CROSS-REFERENCE TO RELATED APPLICATIONS

The present application is the U.S. national stage application of international application PCT/EP2022/067459 filed Jun. 24, 2022, which international application was published on Dec. 29, 2022, as International Publication WO 2022/269090 A1. The international application claims priority to German Patent Application No. 10 2021 003 305.1 filed Jun. 25, 2021. The international and German applications are hereby incorporated by reference herein.

### FIELD

The invention relates to a method for operating a refrigerated vehicle. The invention furthermore relates to a refrigerated vehicle suitable for carrying out the method according to the invention.

### BACKGROUND

Refrigerated vehicles are equipped with a storage region in which temperature-sensitive products can be transported at a temperature of, for example, from 4° C. to 10° C. or as frozen goods at temperatures below 0° C. Conventional refrigerating apparatuses are still often used for the refrigeration, but because of their high emissions of noise, CO₂, NOx and particulates in continuous operation are increasingly being subject to criticism. One available alternative is refrigeration by means of a cryogenic refrigerant. The cryogenic refrigerant, for example liquid nitrogen, is held in the liquid state in a thermally insulated refrigerant tank mounted on the vehicle, and is delivered via a pipeline to the storage region when required. For the refrigeration, the cryogenic refrigerant is sprayed as either a liquid or gas into the storage region (direct refrigeration) or brought into indirect heat contact with the atmosphere in the storage region via a heat exchanger arrangement (indirect refrigeration). Examples of such refrigerated vehicles and of refrigerating systems of refrigerated vehicles are described in WO 2011/141287 A1, EP 1 659 355 A2, GB 2 275 098 A or EP 2 384 916 A2.

During the use of such refrigerated vehicles, the refrigerant tanks need to be periodically recharged in order to replace refrigerant that has evaporated or warmed during the refrigeration of the products. The charging is carried out at private filling stations, for example on the premises of the logistics company that operates the refrigerated vehicles, or at public filling stations. During the charging, either the storage region continues to be refrigerated with cryogenic refrigerant from the refrigerant tank or the refrigeration is interrupted for the duration of the charging.

Sometimes, such filling stations also have two filling lines that need to be connected to the refrigerant tank during the filling: a first line is in this case used to supply liquid cryogenic refrigerant, and a second line is used to discharge refrigerant evaporated in the refrigerant tank during the charging. Since simultaneous connection of the containers via two lines is very elaborate and furthermore entails an increased risk for the operator, more recent developments, for instance the subject matter of WO 2019/042714 A1, allow connection via only one filling line. In this subject matter, the cryogenic refrigerant is brought into a supercooled state before the filling, the effect of which is that the gas phase in the refrigerant tank collapses during the filling process and no longer needs to be discharged via a separate line. Before the start of the filling process, a filling nozzle mounted on the filling line therefore needs merely to be connected in a gas-tight fashion, but releasably, to a corresponding adapter piece of the refrigerant tank.

Filling stations, whether public or private, are generally not operated on the weekend for reasons of cost. Refrigerated vehicles should therefore be used as far as possible so that the storage space no longer contains a product to be delivered at the start of a weekend or another prolonged operating pause, since otherwise the cold chain can no longer reliably be preserved. Products that are nevertheless present therefore need to be unloaded and stored in a refrigerated chamber during the operating pause. Furthermore, the charging of a refrigerant tank which is empty, and therefore warm, after a prolonged operating pause entails considerable loss of refrigerant.

### SUMMARY

The object of the invention is therefore to provide a method for operating a refrigerated vehicle and a refrigerated vehicle, which allows the cold chain to be preserved even over prolonged operating pauses without relocation of products from the refrigerated vehicle being necessary.

This object is achieved by a method and by a refrigerated vehicle having the features of the claims.

According to the invention, the method for operating a refrigerated vehicle that is equipped with a storage region for transporting products to be refrigerated, in which a predefined refrigeration temperature is maintained by direct or indirect heat contact with a cryogenic refrigerant, involves a first operating state of the refrigerated vehicle, during which the refrigerant for refrigerating the storage region is drawn from a refrigerant tank arranged on the refrigerated vehicle, and a second operating state of the refrigerated vehicle, in which the refrigerant for refrigerating the storage region is drawn from a stationary storage tank while bypassing the refrigerant tank.

In the first operating state, also referred to below as the “transport state”, the intended use of the refrigerated vehicle for transporting products to be refrigerated and/or delivering them to customers is carried out. The products to be refrigerated may for example be food products, medical, pharmaceutical, biotechnological or other temperature-sensitive products. In this operating state, the refrigerated vehicle may in principle be moved, although necessary stopping times—for instance when loading and unloading or due to legally prescribed resting times—are not precluded. Such stopping times may, however, be designed so that suitable refrigeration of the storage region by refrigerant from the refrigerant tank can be ensured during this time.

If the amount of refrigerant contained in the refrigerant tank is not sufficient for the intended refrigerating task, the refrigerant tank needs to be charged. During the charging, which may also be regarded as a separate operating state, the refrigerant tank is temporarily connected to a stationary filling station and the refrigerant tank is charged with a defined amount of cryogenic refrigerant. Transport of products to be refrigerated is not possible during this time, even though the storage region may still contain products to be refrigerated. Either the storage region in this case continues to be refrigerated by refrigerant from the refrigerant tank, or refrigeration is not carried out since in many cases the duration of a charging operation is so short that the temperature can be kept below a predefined value during this time even without continued refrigeration.

In the second operating state, also referred to here as “stationary refrigeration”, there is a permanent line connection of the refrigerated vehicle to a static storage tank and the refrigeration of the storage region is carried out by means of cryogenic refrigerant from the storage tank while bypassing the refrigerant tank on the refrigerated vehicle. Similarly as when charging, transport of products to be refrigerated is not possible in this operating state. During the stationary refrigeration, the storage tank fulfills the function of the refrigerant tank. The refrigerant required for refrigerating the storage region is drawn from the storage tank and supplied via the permanent line connection to a refrigerating apparatus arranged in the storage region. The amount of refrigerant released from the storage container over the duration of the stationary refrigeration is in this case dictated by the refrigeration required in the storage region, and a rigidly predefined amount of refrigerant is not released to the refrigerated vehicle—as it is during charging. Since the static storage tank may be selected to be very large, this operating state is for example suitable for prolonged operating pauses of from a few hours to several days in length, in particular for an operating pause on the weekend, or for precooling the refrigerated vehicle to the operating temperature before loading. During the stationary refrigeration, the storage region may be kept at the predefined temperature and it is thus not necessary to relocate the products to be refrigerated from the storage region of the refrigerated vehicle into a refrigerated warehouse or the like.

During the stationary refrigeration, the refrigerant tank is disconnected in terms of flow from the storage region. Refrigerant which is still contained in the refrigerant tank therefore evaporates only at a very slow rate, determined by the insulation of the refrigerant tank, so that there may still be refrigerant in the refrigerant tank after a few days even without prior charging. In many cases, it is therefore possible to return immediately to the transport state at the end of the stationary refrigeration without prior refrigeration of the refrigerant tank to the operating temperature being necessary for this.

Preferably, the drawing of the refrigerant from the stationary storage tank is regulated during the stationary refrigeration as a function of a predefined refrigeration temperature in the storage region. The regulating is preferably carried out with the same regulating unit as is usually present on refrigerated vehicles, which regulates the drawing of refrigerant from the refrigerant tank in the transport state.

Liquid nitrogen or pressure-liquefied carbon dioxide is preferably used as the cryogenic refrigerant in the refrigerated vehicle.

During the aforementioned operating states, refrigeration of the storage region is constantly ensured. In a further operating state, which is not considered in detail here, refrigeration of the storage region is not provided, for instance during an empty journey or during maintenance of the refrigerated vehicle.

A refrigerated vehicle according to the invention is equipped with a storage region intended to receive products to be refrigerated, a refrigerating apparatus arranged in the storage region for refrigerating the atmosphere in the storage region by direct or indirect thermal contact with a cryogenic refrigerant, and with a refrigerant tank which is intended to store the cryogenic refrigerant, and which has an adapter piece for connecting a filling nozzle of a filling station, and with a pipeline connecting the refrigerant tank to the refrigerating apparatus, the pipeline being equipped, in addition to the connection to the refrigerant tank, with a connecting adapter for connection to a stationary storage tank for storing cryogenic refrigerant.

By the connecting adapter on the pipeline, refrigeration of the storage region by refrigerant from the stationary (static) storage tank is possible while bypassing the refrigerant tank on the refrigerated vehicle by the pipeline being connected directly to the storage tank via a line. The connecting adapter is preferably configured as an additional adapter separate from the adapter piece used for filling the refrigerant tank, and preferably has an adapter configuration that is suitable for permanent and not constantly monitored connection, for example a flange connector. The refrigerated vehicle according to the invention therefore allows the “stationary refrigeration” explained above and makes it possible to preserve the cold chain for refrigerated and frozen goods which are contained in the storage region during prolonged operating pauses. Means are in this case preferably provided in terms of flow between the connecting adapter and the refrigerant tank, using which the refrigerant tank can be disconnected from the pipeline, in particular so long as there is a flow connection of the pipeline to the storage tank via the connecting adapter during the stationary refrigeration. These means are, for example, a valve arranged in terms of flow between the connecting adapter and the refrigerant tank. The refrigerant still contained in the refrigerant tank during the stationary refrigeration is therefore no longer used to refrigerate the storage region and is predominantly used to refrigerate the refrigerant tank itself.

Preferably, the refrigerated vehicle has a regulating device, by means of which it is selectively possible to regulate the drawing of refrigerant from the refrigerant tank or from the storage tank as a function of a predefined refrigeration temperature in the storage region and the disconnection of the refrigerant tank during the stationary refrigeration. While the regulating device thus regulates the drawing of refrigerant from the refrigerant tank in the transport state of the refrigerated vehicle, the same regulating device is preferably used during the stationary refrigeration in order to regulate the drawing of refrigerant from the stationary storage tank. An additional regulating device at the location of the storage tank is therefore not necessary.

The refrigerated vehicle is in particular a road vehicle, for instance a refrigerated truck or transport vehicle having a trailer, on the load bed of which a storage region for products to be refrigerated is arranged. The invention is suitable, for example, for refrigerated vehicles that are intended for transporting and/or delivering fresh products (having a storage temperature of between +2° C. and +12° C.) and/or deep-frozen products (having a storage temperature of below −18° C.).

### BRIEF DESCRIPTION OF THE DRAWINGS

An exemplary embodiment of the invention will be explained in more detail with the aid of the drawings.

FIG. 1 schematically shows a refrigerated vehicle in a transport state.

FIG. 2 schematically shows the refrigerated vehicle in a charging state.

FIG. 3 schematically shows the refrigerated vehicle in a stationary refrigeration state.

### DETAILED DESCRIPTION

In a manner known per se, the refrigerated vehicle 1 according to the invention has a storage region 2 equipped with thermally well-insulated walls for receiving chilled goods, in particular for receiving refrigerated or frozen products for which the cold chain must be maintained. In order to produce a cold atmosphere in the storage region 2, a refrigerating apparatus is used, in the exemplary embodiment shown here a heat exchanger 3, at which the atmosphere in the storage region 2 is brought into indirect thermal contact with a cryogenic refrigerant guided through the heat exchanger 3, for example liquid nitrogen or liquid carbon dioxide. The refrigerant is stored in a refrigerant tank 4 mounted on the refrigerated vehicle 1 and is fed through a pipeline 5 to the heat exchanger 3. Depending on the cryogenic refrigerant used, the refrigerant tank 4 and/or pipeline 5 are configured to be pressure-resistant and/or thermally well insulated. After passing through the heat exchanger 3, the refrigerant evaporating during the heat exchange is discharged through an off-gas line 6 without entering the interior of the storage region 2.

In order to maintain a predefined temperature of for example +2° C., +12° C. or −18° C. in the storage region 2, the supply of cryogenic refrigerant to the heat exchanger 3 is controlled via a regulating valve 7 which is actively connected to a temperature sensor 8 arranged in the storage region 2.

The filling of the refrigerant tank 4 with the refrigerant is carried out in the manner described in more detail below via an adapter piece 9, which can be closed tightly against flow by a valve 10. The pipeline 5 is furthermore equipped with an additional connecting adapter 11, which can be opened and closed by means of a valve 12. The connecting adapter 11 is used in the manner described below for connecting to a static storage tank. Also provided, in terms of flow between the connecting adapter 11 and the refrigerant tank 4, is a valve 13 that blocks or opens this part of the pipeline 5. There are furthermore necessary safety fixtures, in particular safety valves, although these are not shown here for reasons of clarity.

In the operating state (“transport state”) which is shown in FIG. 1, the refrigerated vehicle 1 is mobile and ready to transport and deliver products to be refrigerated in the storage region 2 while maintaining the cold chain. The valves 10, 12 are closed, the valve 13 is opened, and the refrigerant tank 4 is filled up to the height of a level 14 with a refrigerant, here liquid nitrogen. Via the regulating valve 7, the liquid nitrogen is transported in a metered fashion to the heat exchanger 3 and evaporated there in indirect heat exchange with the atmosphere of the storage region 2, and is discharged via the off-gas line 6.

By the continuous refrigeration process while transporting the products to be refrigerated, the amount of nitrogen held in the refrigerant tank 4 is reduced. If the level 14 in the refrigerant tank 4 falls below a certain minimum height, the driver of the refrigerated vehicle 1 receives a corresponding signal to charge the refrigerant tank 4.

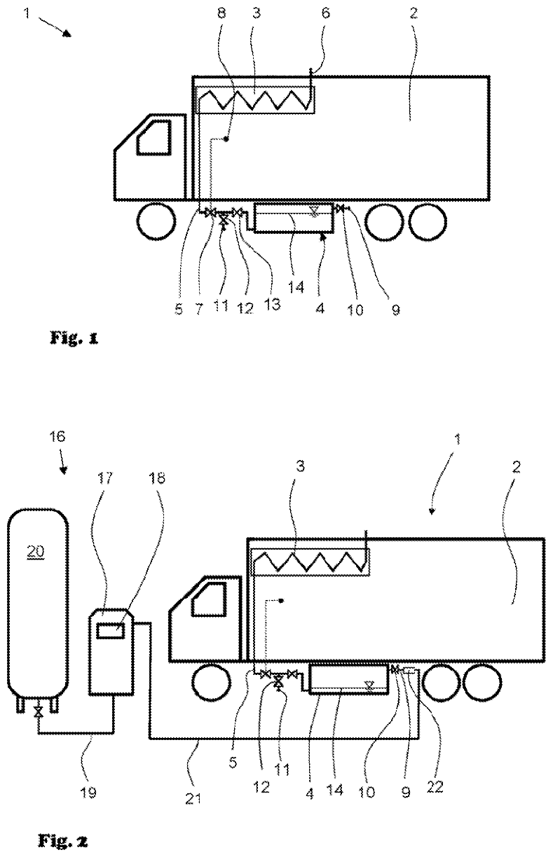

The charging of the refrigerant tank 4 is carried out, as shown in FIG. 2, at a public or private filling station 16 for the cryogenic refrigerant. In the exemplary embodiment shown here, the filling station 16 comprises a filling pump 17 having control and monitoring elements 18 and further devices (not shown here), for example a supercooler. The filling pump 17 is in fluid communication via a refrigerant line 19 with a storage tank 20 for the cryogenic refrigerant. The filling pump 17 is furthermore equipped with a flexible filling line 21, which is suitable for transporting the cryogenic refrigerant in the storage tank 20 and debouches at a filling nozzle 22. The filling nozzle 22 is matched to the adapter piece 9 of the refrigerant tank 4 and allows temporary gas-tight and fluid-tight connection of the filling line 21 to the refrigerant tank 4.

For the filling, the filling nozzle 22 is connected to the adapter piece 9 and the valve 10 is opened. The valve 12 remains closed. The refrigerant tank 4 is subsequently filled with cryogenic refrigerant up to a predefined filling height. The filling process is monitored continuously by the control and monitoring elements 18 and by staff. After the end of the filling process, the valve 10 is closed and the filling nozzle 22 is separated from the adapter piece 9. The refrigerated vehicle 1 is then again ready to transport and deliver chilled goods.

If the refrigerant tank 4 of the refrigerated vehicle 1 cannot be charged during prolonged operating pauses, for example over a weekend, there is a risk that the refrigerant in the refrigerant tank 4 will fully evaporate and the temperature of the atmosphere in the storage region 2 will consequently rise. For such prolonged operating pauses, a further operating state is available to the refrigerated vehicle 1 according to the invention, in which the refrigeration of the storage region 2 is carried out directly from a static storage tank 24 for the cryogenic refrigerant.

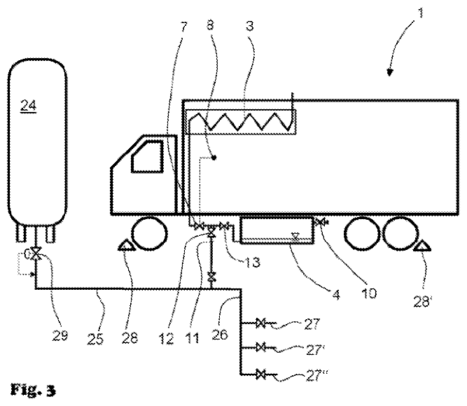

In this operating state (“stationary refrigeration”), which is shown in FIG. 3, the pipeline 5 is in fluid communication via the connecting adapter 11 with a static storage tank 24. The fluid communication is established via a preferably flexible, thermally insulated and/or pressure-resistant connecting line 25, which is firmly but releasably attached on the one hand to the storage tank 25 and on the other hand to the connecting adapter 11. In this operating state, the valve 12 is opened and the valve 13 is closed; the refrigerant tank 4 is thus separated in terms of flow from the pipeline 5. Refrigerant still present in the refrigerant tank 4 is thus no longer used to cool the storage region 2 but serves merely to keep the refrigerant tank 4 at a low temperature during this operating state. The refrigeration of the storage region 2 is carried out exclusively by refrigerant from the storage tank 24, which to this extent fulfills the function of the refrigerant tank 4. The regulating of the temperature in the storage region 2 continues to be carried out via the regulating valve 7 and the temperature sensor 8, although in this case the regulating valve 7 now controls the supply flow of refrigerant from the storage tank 24.

The storage tank 24 may moreover be part of a supply device in which a multiplicity of refrigerated vehicles can be supplied during an operating pause with refrigerant from the storage tank 24. For this purpose, in the exemplary embodiment shown here, a branch line 26 on which a multiplicity of connecting adapters 27, 27′, 27″ are arranged, which can be attached to a corresponding number of refrigerated vehicles to be supplied with cryogenic refrigerant, branches off from the connecting line 25.

It is moreover conceivable that the storage tank 20 of a filling station 16 (FIG. 2) may also be designed for supplying one or more refrigerated vehicles 1 during stationary refrigeration. In this case, the storage tank 20 (not shown here) has additional adapters for connecting the storage tank 20 to a pipeline 5 of a refrigerated vehicle 1, in a similar way to the adapters 27, 27′, 27″ of the storage tank 24.

If the refrigerated vehicle 1 is not under constant monitoring by supervisors throughout the operating pause, precautions for the safety of the refrigerated vehicle 1 and the fluid communication with the storage tank 24 are necessary, which are to be established depending on the situation in each individual case. These may for example include brake chocks 28 that prevent the refrigerated vehicle 1 rolling away, or a safety valve 29 that, in case of a sudden pressure drop in the connecting line 25, which implies a line break, automatically prevents refrigerant being drawn from the storage tank 24 or—not shown here-remote monitoring means that automatically recognize the occurrence of an undesired event and send a warning signal to a central control room.

After the end of the stationary refrigeration, the valve 12 is closed and the connecting line 25 is released from the connecting adapter 11. The valve 13 is opened and the storage region 2 is again refrigerated by the refrigerant still present in the refrigerant tank 4. The refrigerated vehicle 1 is immediately ready for use-optionally after charging the refrigerant tank 4.

In the refrigerated vehicle 1 according to the invention, the cold chain for fresh or deep-frozen products contained in the storage region 2 may be preserved even during prolonged operating pauses of several days in length, without it being necessary to relocate the products from the refrigerated vehicle 1.

### LIST OF REFERENCE SIGNS

1 refrigerated vehicle
2 storage region
3 heat exchanger
4 refrigerant tank
pipeline
6 off-gas line
7 regulating valve
8 temperature sensor
9 adapter piece
valve
11 connecting adapter
12 valve
13 valve
14 level
15 -
16 filling station
17 filling pump
18 control and monitoring elements
19 refrigerant line
20 storage tank
21 filling line
22 filling nozzle
23 -
24 storage tank
25 connecting line
26 branch line
27, 27′, 27″ connecting adapter
28, 28′ brake chock
29 safety valve

1. A method for operating a refrigerated vehicle that is equipped with a storage region for transporting products to be refrigerated, in which a predefined refrigeration temperature is maintained by direct or indirect heat contact with a cryogenic refrigerant, wherein in a first operating state of the refrigerated vehicle the refrigerant for refrigerating the storage region is drawn from a refrigerant tank arranged on the refrigerated vehicle; and
wherein in a second operating state of the refrigerated vehicle, the refrigerant for refrigerating the storage region is drawn from a stationary storage tank while bypassing the refrigerant tank.

2. The method as claimed in claim 1, wherein the drawing of cryogenic refrigerant from the refrigerant tank in the first operating state and/or from the stationary storage tank in the second operating state is regulated as a function of a refrigerant temperature in the storage region.

3. The method as claimed in claim 1, characterized in that, wherein liquid nitrogen or pressure-liquefied carbon dioxide is used as the cryogenic refrigerant.

4. A refrigerated vehicle having:
a storage region intended to receive products to be refrigerated;
a refrigerating apparatus arranged in the storage region for refrigerating the atmosphere in the storage region by direct or indirect thermal contact with a cryogenic refrigerant; and
a refrigerant tank which is intended to store the cryogenic refrigerant and is in fluid communication with the refrigerating apparatus via a pipeline, and which has an adapter piece for connecting a filling nozzle of a filling station;
wherein the pipeline is equipped, in addition to the connection to the refrigerant tank, with a connecting adapter for connection to a storage tank for storing cryogenic refrigerant.

5. The refrigerated vehicle as claimed in claim 4, wherein means for disconnecting the refrigerant tank from the pipeline are provided in terms of flow between the connecting adapter and the refrigerant tank.

6. The refrigerated vehicle as claimed in claim 4, further comprising a regulating device to regulate the drawing of refrigerant from the refrigerant tank and/or from the storage tank as a function of a predefined refrigeration temperature in the storage region.

7. The refrigerated vehicle as claimed in claim 4, wherein a road vehicle is used as the refrigerated vehicle.
